(19) United States
(12) Patent Application Publication
(10) Pub. No.: US 2026/0188899 A1
(43) Pub. Date: Jul. 2, 2026

(54) ANTENNA, ANTENNA ARRAY, AND ELECTRONIC DEVICE

(71) Applicants: Beijing BOE Sensor Technology Co., Ltd., Beijing (CN); BOE TECHNOLOGY GROUP CO., LTD., Beijing (CN)

(72) Inventors: Lu CHEN, Beijing (CN); Yiming WANG, Beijing (CN); Xiaoqiang YANG, Beijing (CN); Wei ZHAO, Beijing (CN); Mengjiao LI, Beijing (CN); Zhifeng ZHANG, Beijing (CN)

(21) Appl. No.: 18/727,651

(22) PCT Filed: Apr. 20, 2023
(86) PCT No.: PCT/CN2023/089381

§ 371 Date: Jul. 9, 2024

(51) Int. Cl. H01Q 3/26; H01Q 1/50

(52) U.S. Cl. CPC H01Q 3/26; H01Q 1/50

(57) ABSTRACT

An antenna includes first and second phase adjustment structures, first and second feed lines, and a first radiation structure. The first phase adjustment structure includes first and second transmission lines, and the second phase adjustment structure comprises third and fourth transmission lines. Each of the first and second feed lines has a first end and a second end. The first end of the first feed line, the second end of the first feed line, the first end of the second feed line, and the second end of the second feed line are electrically connected to the first transmission line, the second transmission line, the third transmission line, and the fourth transmission line, respectively. The first and second feed lines are both electrically connected to the first radiation structure, and a feed direction of the first feed line is different from a feed direction of the second feed line.

### CROSS-REFERENCE TO RELATED APPLICATIONS

This is a National Phase Application filed under 35 U.S.C. 371 as a national stage of PCT/CN2023/089381 filed on Apr. 20, 2023, the entire content of which is incorporated herein by reference.

### TECHNICAL FIELD

The present disclosure relates to the field of communication technology, and in particular, to an antenna, an antenna array, and an electronic device.

### BACKGROUND

A phase shifter may be regarded as an important component of an antenna, and may be regarded as a time delay line. A phase shifter with a variable phase may be obtained by replacing a traditional solid substrate with a tunable dielectric material, and liquid crystals may be used as the tunable dielectric material. A liquid crystal phase shifter is a phase shifter with a variable phase (i.e., a phase-variable phase shifter), and a voltage is applied across an upper substrate and a lower substrate of the liquid crystal phase shifter to form an overlapping capacitor, such that a dielectric constant of a liquid crystal material is changed, a phase of an electromagnetic wave on the liquid crystal phase shifter is changed, an effect of adjusting a phase shift amount is finally achieved, and a wavenumber scanning function of an antenna is realized. At present, a traditional liquid crystal antenna is single-polarized, and a dual-polarized antenna is very complex in design in which a layout of phase shift units and a layout of wiring especially need to be considered. Therefore, it is an urgent desire to provide a dual-polarized antenna which has a simple structure and can be implemented easily.

### SUMMARY

To solve at least one of technical problems in the prior art, the present disclosure provides an antenna, an antenna array, and an electronic device.

In a first aspect, embodiments of the present disclosure provide an antenna, including a first phase adjustment structure, a second phase adjustment structure, a first feed line, a second feed line, and a first radiation structure, wherein
the first phase adjustment structure includes a first transmission line and a second transmission line, and the second phase adjustment structure includes a third transmission line and a fourth transmission line;
each of the first feed line and the second feed line has a first end and a second end, the first end of the first feed line is electrically connected to the first transmission line, the second end of the first feed line is electrically connected to the second transmission line, the first end of the second feed line is electrically connected to the third transmission line, and the second end of the second feed line is electrically connected to the fourth transmission line; and
the first feed line and the second feed line are both electrically connected to the first radiation structure, and a feed direction of the first feed line is different from a feed direction of the second feed line.

In an embodiment, a feed point for the first feed line to feed the first radiation structure is a first feed point, a feed point for the second feed line to feed the first radiation structure is a second feed point, the first feed point divides the first feed line into a first sub-feed line and a second sub-feed line, and the second feed point divides the second feed line into a third sub-feed line and a fourth sub-feed line; and
a length of the first sub-feed line is equal to a length of the second sub-feed line, and a length of the third sub-feed line is equal to a length of the fourth sub-feed line.

In an embodiment, at least one of the first sub-feed line and the second sub-feed line of the first feed line includes a serpentine line, and/or at least one of the third sub-feed line and the fourth sub-feed line of the second feed line includes a serpentine line.

In an embodiment, the first feed line and the second feed line are arranged to be mirror-symmetrical to each other. 5. In an embodiment, the antenna further includes: a first dielectric substrate and a second dielectric substrate which are opposite to each other, a first reference electrode layer arranged on a side of the second dielectric substrate distal to the first dielectric substrate, a third dielectric substrate arranged on a side of the first reference electrode layer distal to the first dielectric substrate, and a second reference electrode layer arranged on a side of the first dielectric substrate distal to the second dielectric substrate; and
the first phase adjustment structure and the second phase adjustment structure are disposed between the first dielectric substrate and the second dielectric substrate, the first radiation structure is disposed on a side of the third dielectric substrate distal to the first reference electrode layer, the first reference electrode layer has therein a first opening and a second opening, the first feed line is electrically connected to the first radiation structure through the first opening, and the second feed line is electrically connected to the first radiation structure through the second opening.

In an embodiment, the antenna further includes: a first dielectric substrate and a second dielectric substrate which are opposite to each other, a first reference electrode layer arranged on a side of the second dielectric substrate distal to the first dielectric substrate, a third dielectric substrate arranged on a side of the first reference electrode layer distal to the first dielectric substrate, a second reference electrode layer arranged on a side of the first dielectric substrate distal to the second dielectric substrate, a fourth dielectric substrate disposed on a side of the second reference electrode layer distal to the first dielectric substrate, and a second radiation structure disposed on a side of the fourth dielectric substrate distal to the second reference electrode layer;
the first phase adjustment structure and the second phase adjustment structure are disposed between the first dielectric substrate and the second dielectric substrate, and the first radiation structure is disposed on a side of the third dielectric substrate distal to the first reference electrode layer;
the first reference electrode layer has therein a first opening and a second opening, the first feed line is electrically connected to the first radiation structure through the first opening, and the second feed line is electrically connected to the first radiation structure through the second opening; and
the second reference electrode layer has therein a third opening and a fourth opening, a first transmission assembly of the first phase adjustment structure is electrically connected to the second radiation structure through the third opening, and a first transmission assembly of the second phase adjustment structure is electrically connected to the second radiation structure through the fourth opening.

In an embodiment, the first transmission assembly of the first phase adjustment structure includes a third feed line, and the first transmission assembly of the second phase adjustment structure includes a fourth feed line; and
each of the third feed line and the fourth feed line has a first end and a second end, the first end of the third feed line is electrically connected to the first transmission line, the second end of the third feed line is electrically connected to the second transmission line, the first end of the fourth feed line is electrically connected to the third transmission line, and the second end of the fourth feed line is electrically connected to the fourth transmission line.

In an embodiment, a feed point for the third feed line to feed the second radiation structure is a third feed point, a feed point for the fourth feed line to feed the second radiation structure is a fourth feed point, the third feed point divides the third feed line into a fifth sub-feed line and a sixth sub-feed line, and the fourth feed point divides the fourth feed line into a seventh sub-feed line and an eighth sub-feed line; and
a length of the fifth sub-feed line is equal to a length of the sixth sub-feed line, and a length of the seventh sub-feed line is equal to a length of the eighth sub-feed line.

In an embodiment, at least one of the fifth sub-feed line and the sixth sub-feed line of the third feed line includes a serpentine line, and/or at least one of the seventh sub-feed line and the eighth sub-feed line of the fourth feed line includes a serpentine line.

In an embodiment, the third feed line and the fourth feed line are arranged to be mirror-symmetrical to each other.

In an embodiment, the third opening and the fourth opening are arranged to be mirror-symmetrical to each other.

In an embodiment, the antenna further includes: a first dielectric substrate and a second dielectric substrate which are opposite to each other, a first reference electrode layer arranged on a side of the second dielectric substrate distal to the first dielectric substrate, a third dielectric substrate arranged on a side of the first reference electrode layer distal to the first dielectric substrate, a second reference electrode layer arranged on a side of the first dielectric substrate distal to the second dielectric substrate, a fourth dielectric substrate disposed on a side of the second reference electrode layer distal to the first dielectric substrate, and a first feed source and a second feed source which are disposed on a side of the fourth dielectric substrate distal to the second reference electrode layer;
the first phase adjustment structure and the second phase adjustment structure are disposed between the first dielectric substrate and the second dielectric substrate, and the first radiation structure is disposed on a side of the third dielectric substrate distal to the first reference electrode layer;
the first reference electrode layer has therein a first opening and a second opening, the first feed line is electrically connected to the first radiation structure through the first opening, and the second feed line is electrically connected to the first radiation structure through the second opening; and
the second reference electrode layer has therein a third opening and a fourth opening, the first feed source is electrically connected to a first transmission assembly of the first phase adjustment structure through the third opening, and the second feed source is electrically connected to a first transmission assembly of the second phase adjustment structure through the fourth opening.

In an embodiment, the first transmission assembly of the first phase adjustment structure includes a third feed line, and the first transmission assembly of the second phase adjustment structure includes a fourth feed line; and
each of the third feed line and the fourth feed line has a first end and a second end, the first end of the third feed line is electrically connected to the first transmission line, the second end of the third feed line is electrically connected to the second transmission line, the first end of the fourth feed line is electrically connected to the third transmission line, and the second end of the fourth feed line is electrically connected to the fourth transmission line.

In an embodiment, a feed point for the third feed line to feed the first feed source is a third feed point, a feed point for the fourth feed line to feed the second feed source is a fourth feed point, the third feed point divides the third feed line into a fifth sub-feed line and a sixth sub-feed line, and the fourth feed point divides the fourth feed line into a seventh sub-feed line and an eighth sub-feed line; and
a length of the fifth sub-feed line is equal to a length of the sixth sub-feed line, and a length of the seventh sub-feed line is equal to a length of the eighth sub-feed line.

In an embodiment, at least one of the fifth sub-feed line and the sixth sub-feed line of the third feed line includes a serpentine line, and/or at least one of the seventh sub-feed line and the eighth sub-feed line of the fourth feed line includes a serpentine line.

In an embodiment, the third feed line and the fourth feed line are arranged to be mirror-symmetrical to each other.

In an embodiment, the third opening and the fourth opening are arranged to be mirror-symmetrical to each other.

In an embodiment, the first opening and the second opening are arranged to be mirror-symmetrical to each other.

In an embodiment, the first phase adjustment structure includes a first electrode layer disposed on a side of a first dielectric substrate proximal to a second dielectric substrate, a second electrode layer disposed on a side of the second dielectric substrate proximal to the first dielectric substrate, and a first tunable dielectric layer disposed between the first electrode layer and the second electrode layer, wherein the first transmission line is positioned in the first electrode layer, and the second transmission line is positioned in the second electrode layer;
and/or
the second phase adjustment structure includes a third electrode layer disposed on the side of the first dielectric substrate proximal to the second dielectric substrate, a fourth electrode layer disposed on the side of the second dielectric substrate proximal to the first dielectric substrate, and a second tunable dielectric layer disposed between the third electrode layer and the fourth electrode layer, wherein the third transmission line is positioned in the third electrode layer, and the fourth transmission line is positioned in the fourth electrode layer.

In an embodiment, the first phase adjustment structure includes a first electrode layer disposed on a side of a first dielectric substrate proximal to a second dielectric substrate, a second electrode layer disposed on a side of the second dielectric substrate proximal to the first dielectric substrate, and a first tunable dielectric layer disposed between the first electrode layer and the second electrode layer, wherein the first transmission line and the second transmission line are positioned in the first electrode layer, the second electrode layer includes a plurality of first patch electrodes, and orthogonal projections of both the first transmission line and the second transmission line on the first dielectric substrate overlap with an orthogonal projection of each of the plurality of first patch electrodes on the first dielectric substrate;
and/or
the second phase adjustment structure includes a third electrode layer disposed on the side of the first dielectric substrate proximal to the second dielectric substrate, a fourth electrode layer disposed on the side of the second dielectric substrate proximal to the first dielectric substrate, and a second tunable dielectric layer disposed between the third electrode layer and the fourth electrode layer,, wherein the third transmission line and the fourth transmission line are positioned in the third electrode layer, the fourth electrode layer includes a plurality of second patch electrodes, and orthogonal projections of both the third transmission line and the fourth transmission line on the first dielectric substrate overlap with an orthogonal projection of each of the plurality of second patch electrodes on the first dielectric substrate.

Embodiments of the present disclosure provide an antenna array, which includes a plurality of antennas each of which is the antenna according to any one of the foregoing embodiments.

In an embodiment, the plurality of antennas are divided into a plurality of first antenna groups arranged side by side along a second direction and a plurality of second antenna groups arranged side by side along a first direction, wherein the antennas in each first antenna group are arranged side by side along the first direction, and the antennas in each second antenna group are arranged side by side along the second direction;
the first phase adjustment structure includes a first electrode layer disposed on a side of a first dielectric substrate proximal to a second dielectric substrate, a second electrode layer disposed on a side of the second dielectric substrate proximal to the first dielectric substrate, and a first tunable dielectric layer disposed between the first electrode layer and the second electrode layer; the second phase adjustment structure includes a third electrode layer disposed on the side of the first dielectric substrate proximal to the second dielectric substrate, a fourth electrode layer disposed on the side of the second dielectric substrate proximal to the first dielectric substrate, and a second tunable dielectric layer disposed between the third electrode layer and the fourth electrode layer; wherein the first electrode layer and the third electrode layer are arranged in a same layer, and the second electrode layer and the fourth electrode layer are arranged in a same layer; and
   in each second antenna group, first electrode layers are connected to separate first bias voltage lines, respectively, third electrode layers are connected to a same third bias voltage line, second electrode layers are connected to a same second bias voltage line, and fourth electrode layers are connected to separate fourth bias voltage lines, respectively;
   or
   in each second antenna group, first electrode layers are connected to a same first bias voltage line, third electrode layers are connected to separate third bias voltage lines, respectively, second electrode layers are connected to separate second bias voltage lines, respectively, and fourth electrode layers are connected to a same fourth bias voltage line.

In an embodiment, the plurality of antennas are divided into a plurality of first antenna groups arranged side by side along a second direction and a plurality of second antenna groups arranged side by side along a first direction, wherein the antennas in each first antenna group are arranged side by side along the first direction, and the antennas in each second antenna group are arranged side by side along the second direction;
the first phase adjustment structure includes a first electrode layer disposed on a side of a first dielectric substrate proximal to a second dielectric substrate, a second electrode layer disposed on a side of the second dielectric substrate proximal to the first dielectric substrate, and a first tunable dielectric layer disposed between the first electrode layer and the second electrode layer; the second phase adjustment structure includes a third electrode layer disposed on the side of the first dielectric substrate proximal to the second dielectric substrate, a fourth electrode layer disposed on the side of the second dielectric substrate proximal to the first dielectric substrate, and a second tunable dielectric layer disposed between the third electrode layer and the fourth electrode layer; wherein the first electrode layer and the third electrode layer are arranged in a same layer, and the second electrode layer and the fourth electrode layer are arranged in a same layer; and
   in each first antenna group, first electrode layers are connected to separate first bias voltage lines, respectively, third electrode layers are connected to a same third bias voltage line, second electrode layers are connected to a same second bias voltage line, and fourth electrode layers are connected to separate fourth bias voltage lines, respectively;
   or
   in each first antenna group, first electrode layers are connected to a same first bias voltage line, third electrode layers are connected to separate third bias voltage lines, respectively, second electrode layers are connected to separate second bias voltage lines, respectively, and fourth electrode layers are connected to a same fourth bias voltage line.

Embodiments of the present disclosure provide an electronic device, which includes the antenna according to any one of the foregoing embodiments or the antenna array according to any one of the foregoing embodiments.

### BRIEF DESCRIPTION OF THE DRAWINGS

FIG. 1 is a schematic diagram illustrating an exemplary liquid crystal phase shifter.

FIG. 2 is a schematic diagram illustrating a part of a first exemplary differential phase shifter.

FIG. 3 is a sectional view taken along a line A-A′ shown in FIG. 2.

FIG. 4 is a schematic diagram illustrating a part of a second exemplary differential phase shifter.

FIG. 5 is a sectional view taken along a line B-B′ shown in FIG. 4.

FIG. 6 is a top view illustrating an antenna according to an embodiment of the present disclosure.

FIG. 7 is a schematic diagram illustrating a relative positional relationship among a first opening, a second opening, a first feed line, and a second feed line of an antenna according to an embodiment of the present disclosure.

FIG. 8 is a sectional view illustrating a first exemplary antenna according to an embodiment of the present disclosure.

FIG. 9 is a schematic diagram illustrating a first opening and a second opening according to an embodiment of the present disclosure.

FIG. 10 is a schematic diagram illustrating wire winding of a first feed line and a second feed line according to an embodiment of the present disclosure.

FIG. 11 is a schematic diagram illustrating relative positions of a first phase adjustment structure and a second phase adjustment structure according to an embodiment of the present disclosure.

FIG. 12 is a schematic diagram illustrating another relative positional relationship among a first opening, a second opening, a first feed line, and a second feed line according to an embodiment of the present disclosure.

FIG. 13 is a sectional view illustrating a second exemplary antenna according to an embodiment of the present disclosure.

FIG. 14 is a sectional view illustrating a third exemplary antenna according to an embodiment of the present disclosure.

FIG. 15 is a schematic diagram illustrating a first/second radiation structure according to an embodiment of the present disclosure.

FIG. 16 is a schematic diagram illustrating a layout of an antenna array according to an embodiment of the present disclosure.

FIG. 17 is a schematic diagram illustrating another layout of an antenna array according to an embodiment of the present disclosure.

### DETAILED DESCRIPTION OF EMBODIMENTS

To make technical solutions of the present disclosure be better understood by one of ordinary skill in the art, the present disclosure will be further described in detail with reference to the accompanying drawings and exemplary embodiments below.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather is used for distinguishing one element from another. Further, the use of “a”, “an”, “the”, or the like does not denote a limitation of quantity, but rather denote the presence of at least one. The term of “comprising”, “including”, or the like means that the element or item preceding the term contains the element or item listed after the term and its equivalent, but does not exclude the presence of other elements or items. The term “connected”, “coupled”, or the like is not limited to physical or mechanical connections, but may include electrical connections, whether direct or indirect. The terms “upper”, “lower”, “left”, “right”, and the like are used only for indicating relative positional relationships, and when the absolute position of an object being described is changed, the relative positional relationships may also be changed accordingly.

A balun (i.e., balance-unbalance) assembly is a three-port (or three-terminal) device that may be applied to a microwave radio frequency device. The balun assembly is a radio frequency transmission line transformer that converts a matching input into a differential input, and may be used for exciting a differential line, an amplifier, a wideband antenna, a balanced mixer, a balanced frequency multiplier and modulator, a phase shifter, and any circuit design that requires transmission of signals with equal amplitudes and a phase difference of 180° on two lines. Here, two outputs of the balun assembly have equal amplitudes and opposite phases, which means that there is a phase difference of 180° between the two outputs in the frequency domain, and that a voltage of one balanced output is the negative value of a voltage of the other balanced output in the time domain.

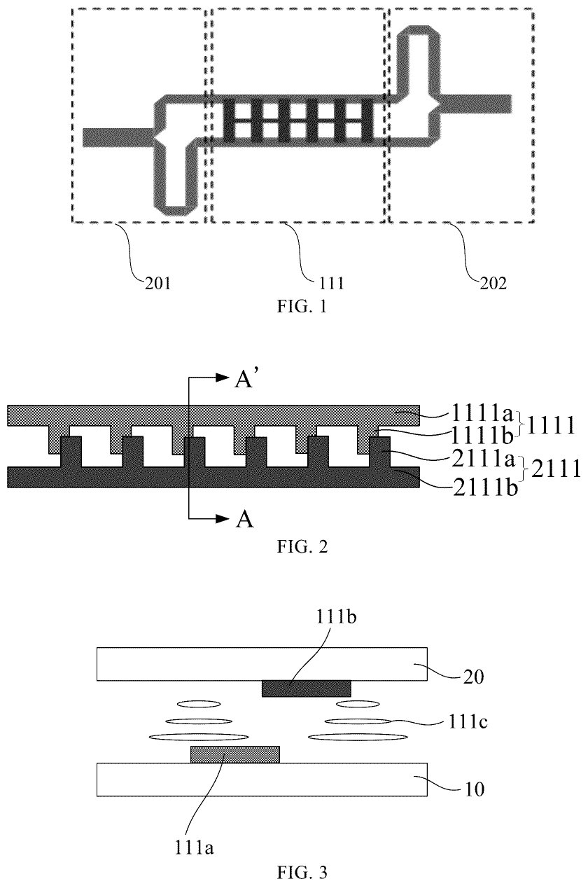

FIG. 1 is a schematic diagram illustrating an exemplary liquid crystal phase shifter. As shown in FIG. 1, the main characteristic of a differential liquid crystal phase shifter is that it has a higher phase shifting efficiency when operating in a differential mode as compared with a single line phase shifter. However, in order to provide a differential mode signal, a balun assembly 201 and a balun assembly 202 are required to be added to an input terminal and an output terminal of a phase shifter 111, respectively, so as to complete the unbalanced-balanced-unbalanced signal conversion.

A phase shifting portion of a phase shifter generally includes a first electrode layer disposed on a side of a first dielectric substrate proximal to a second dielectric substrate, a second electrode layer disposed on a side of the second dielectric substrate proximal to the first dielectric substrate, and a tunable (i.e., adjustable) dielectric layer disposed between the first electrode layer and the second electrode layer. For a liquid crystal phase shifter, the tunable dielectric layer is a liquid crystal layer. Two different differential liquid crystal phase shifters each formed by a first electrode layer and a second electrode layer will be described below.

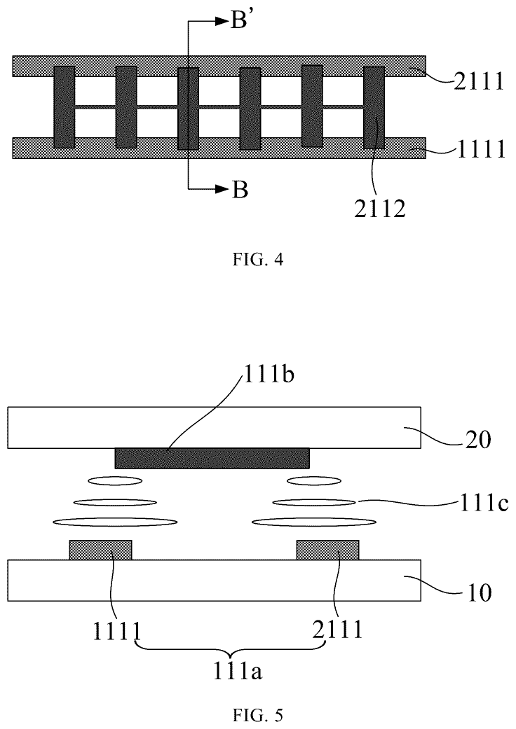

In a first example, FIG. 4 is a schematic diagram illustrating a part of a first exemplary differential phase shifter, and FIG. 5 is a sectional view taken along a line B-B′ shown in FIG. 4. As shown in FIGS. 4 and 5, a first electrode layer 111a of the phase shifter includes a first transmission line 1111 and a second transmission line 2111 extending in a same direction (i.e., having a same extending direction), and a second electrode layer 111b of the phase shifter includes a plurality of patch electrodes 2112 arranged side by side along the extending direction of the first transmission line 1111. An orthogonal projection of each of the first transmission line 1111 and the second transmission line 2111 on the first dielectric substrate 10 overlaps with an orthogonal projection of each of the plurality of patch electrodes 2112 on the first dielectric substrate 10. In this case, the liquid crystal layer is positioned between the first transmission line 1111 and the second transmission line 2111. An overlapping region of each patch electrode 2112 with each of the first transmission line 1111 and the second transmission line 2111 forms a capacitor region, and by applying different voltages to the first transmission line 1111, the second transmission line 2111, and the patch electrodes 2112, an electric field is formed in the overlapping region of the first transmission line 1111 with each patch electrode 2112 and in the overlapping region of the second transmission line 2111 with each patch electrode 2112, such that a dielectric constant of liquid crystal molecules of the liquid crystal layer 111c in the overlapping region of the first transmission line 1111 with each patch electrode 2112 and the overlapping region of the second transmission line 2111 with each patch electrode 2112 is changed, thereby realizing a phase shift of a microwave signal.

In a second example, FIG. 2 is a schematic diagram illustrating a part of a second exemplary differential phase shifter, and FIG. 3 is a sectional view taken along a line A-A′ shown in FIG. 2. As shown in FIGS. 2 and 3, the first electrode layer 111a of the phase shifter includes a first transmission line 1111, and the second electrode layer 111b of the phase shifter includes a second transmission line 2111. The first transmission line 1111 includes a first main line 1111a and first branches 1111b, and the second transmission line 2111 includes a second main line 2111a and second branches 2111b. The first branches 1111b are connected to a side of the first main line 1111a along the extending direction of the first main line 1111a, and both the first main line 1111a and the first branches 1111b are provided on a side of the first dielectric substrate 10 proximal to the liquid crystal layer. The second branches 2111b are connected to a side of the second main line 2111a along the extending direction of the second main line 2111a, and both the second main line 2111a and the second branches 2111b are provided on a side of the second dielectric substrate 20 proximal to the liquid crystal layer. An orthogonal projection of each first branch 1111b on the first dielectric substrate 10 and an orthogonal projection of one of the second branches 2111b on the first dielectric substrate 10 at least partially overlap with each other to define an overlapping region (i.e., a capacitor region), and the overlapping region is located between an orthogonal projection of the first main line 1111a on the first dielectric substrate 10 and an orthogonal projection of the second main line 2111a on the first dielectric substrate 10. By applying a bias voltage across the first main line 1111a and the second main line 2111a, an electric field is formed in the capacitor region to change the dielectric constant of the liquid crystal molecules, thereby shifting (i.e., changing) a phase of a microwave signal.

In an existing dual-polarized antenna, two phase shifters are needed to perform phase adjustment on an electromagnetic wave fed into a radiation structure, and due to the limited space, adopting a phase shifter including a balun structure will inevitably cause problems such as space limitation. Therefore, embodiments of the present disclosure provide the following technical solutions.

It should be noted that each of a first phase adjustment structure 11 and a second phase adjustment structure 21 to be described in the following embodiments of the present disclosure includes, but is not limited to, the liquid crystal phase shifter according to any one of the foregoing embodiments. Further, the following embodiments of the present disclosure will be described by taking an example in which a phase shifter is the liquid crystal phase shifter, i.e., each of a first tunable dielectric layer 111c of the first phase adjustment structure 11 and a first tunable electrode layer 211c of the second phase adjustment structure 21 is a liquid crystal layer.

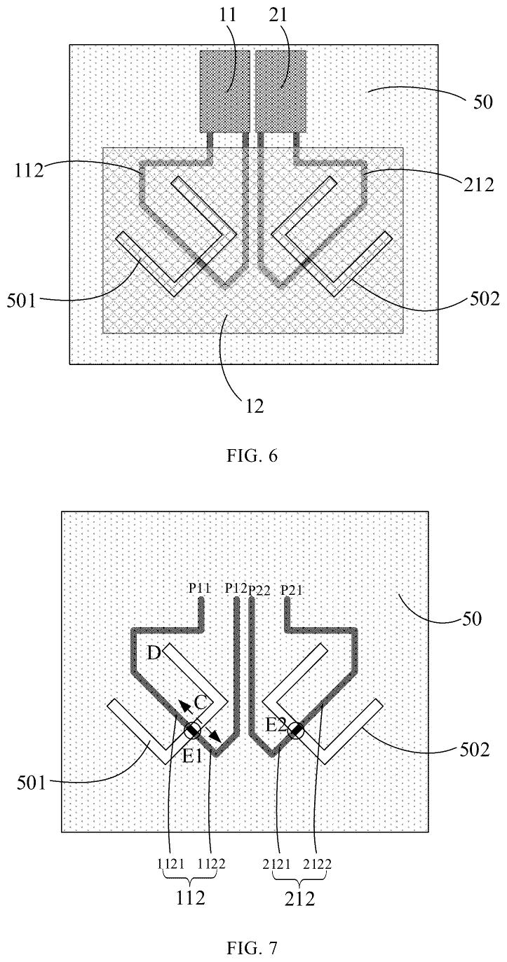

FIG. 6 is a top view illustrating an antenna according to an embodiment of the present disclosure, and FIG. 7 is a schematic diagram illustrating a relative positional relationship among a first opening 501, a second opening 502, a first feed line 112, and a second feed line 212 of an antenna according to an embodiment of the present disclosure. As shown in FIGS. 6 and 7, the present embodiment provides an antenna, which is a dual-polarized antenna, and includes the first phase adjustment structure 11, the second phase adjustment structure 21, the first feed line 112, the second feed line 212, and a first radiation structure 12. The first phase adjustment structure 11 includes the first transmission line 1111 and the second transmission line 2111, and the second phase adjustment structure 21 includes a third transmission line and a fourth transmission line. The first feed line 112 has a first end P11 and a second end P12, and the second feed line 212 has a first end P21 and a second end P22. The first end P11 of the first feed line 112 is electrically connected to the first transmission line 1111, and the second end P12 of the first feed line 112 is electrically connected to the second transmission line 2111. The first end P21 of the second feed line 212 is electrically connected to the third transmission line, and the second end P22 of the second feed line 212 is electrically connected to the fourth transmission line. The first feed line 112 and the second feed line 212 are both electrically connected to the first radiation structure 12, and a feed direction of the first feed line 112 and a feed direction of the second feed line 212 are different from each other. In an embodiment of the present disclosure, as an example, the feed direction of the first feed line 112 and the feed direction of the second feed line 212 are two directions perpendicular to each other.

Specifically, the antenna includes not only the first phase adjustment structure 11, the second phase adjustment structure 21, the first feed line 112, the second feed line 212, and the first radiation structure 12, but also the first dielectric substrate 10, the second dielectric substrate 20, and a first reference electrode layer 50. The first reference electrode layer 50 has therein the first opening 501 and the second opening 502, and the first reference electrode layer is disposed on a side of the second dielectric substrate 20 distal to the first dielectric substrate 10. The first feed line 112 is coupled to the first radiation structure 12 through the first opening 501, and the second feed line 212 is coupled to the first radiation structure 12 through the second opening 502.

In the present embodiment, both ends of the first feed line 112 are electrically connected to the first transmission line 1111 and the second transmission line 2111, respectively, to form a ring feed line (or a ring feeder line), and both ends of the second feed line 212 are electrically connected to the third transmission line and the fourth transmission line, respectively, to form a ring feed line. An electromagnetic wave signal at feed points (or feeding points) of the ring feed line to the radiation structure is divided into two signals having equal amplitudes and opposite phases, such that the electromagnetic wave signals at the first end and the second end of the first feed line 112 can have equal amplitudes and opposite phases by reasonably designing line lengths of two transmission paths. Similarly, electromagnetic wave signals at the first end and the second end of the second feed line 212 can have equal amplitudes and opposite phases, such that a transmission assembly (e.g., a balun assembly) in each of the first phase adjustment structure 11 and the second phase adjustment structure 21 can be omitted, which is more convenient for arranging devices in the antenna.

In some examples, a feed point for the first feed line 112 to feed a signal to the first radiation structure 12 is a first feed point E1, and a feed point for the second feed line 212 to feed a signal to the first radiation structure 12 is a second feed point E2. The first feed point El divides the first feed line 112 into a first sub-feed line 1121 and a second sub-feed line 1122, and the second feed point E2 divides the second feed line 212 into a third sub-feed line 2121 and a fourth sub-feed line 2122. A length of the first sub-feed line 1121 and a length of the second sub-feed line 1122 are equal to each other, and a length of the third sub-feed line 2121 and a length of the fourth sub-feed line 2122 are equal to each other. In this case, it can be realized that the electromagnetic wave signals at the first and second ends of the first feed line 112 have equal amplitude and opposite phases, and the electromagnetic wave signals at the first and second ends of the second feed line 212 have equal amplitudes and opposite phases.

Further, wire winding of the first feed line 112 and the second feed line 212 may be design to reduce a size thereof, for example, at least one of the first sub-feed line 1121 and the second sub-feed line 1122 of the first feed line 112 includes a serpentine line (i.e., a meandering line), and/or, at least one of the third sub-feed line 2121 and the fourth sub-feed line 2122 of the second feed line 212 includes a serpentine line.

Further, the first feed line 112 and the second feed line 212 may be arranged to be mirror-symmetrical to each other (i.e., arranged in mirror symmetry), to reduce the size thereof.

The antenna according to an embodiment of the present disclosure may be any one of a reflective antenna, a transmissive antenna, and a phased array antenna, which will be described in detail below as examples.

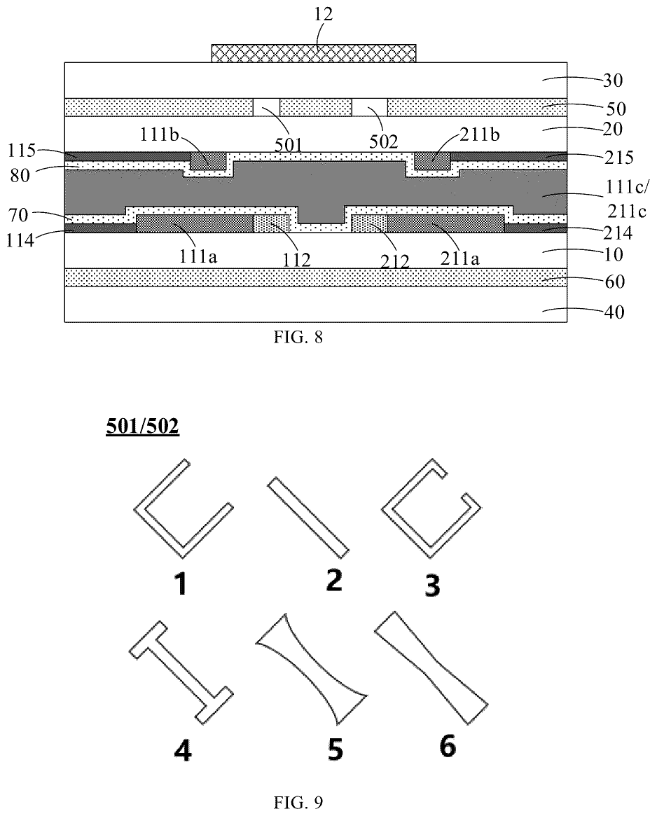

In a first exemplary embodiment, FIG. 8 is a sectional view illustrating a first exemplary antenna according to an embodiment of the present disclosure. As shown in FIGS. 6 to 8, the antenna is a reflective antenna, and includes not only the first phase adjustment structure 11, the second phase adjustment structure 21, the first feed line 112, the second feed line 212, and the first radiation structure 12, but also the first dielectric substrate 10, the second dielectric substrate 20, the first reference electrode layer 50, and a second reference electrode layer 60. The first phase adjustment structure 11 and the second phase adjustment structure 21 are integrated between the first dielectric substrate 10 and the second dielectric substrate 20. The first reference electrode layer 50 has therein the first opening 501 and the second opening 502, and the first reference electrode layer is disposed on a side of the second dielectric substrate 20 distal to the first dielectric substrate 10. The first feed line 112 is coupled to the first radiation structure 12 through the first opening 501, and the second feed line 212 is coupled to the first radiation structure 12 through the second opening 502. The second reference electrode layer 60 is arranged on a side of the first dielectric substrate 10 distal to the second dielectric substrate 20, and serves as a reflective layer. In this case, after receiving an electromagnetic wave, the first radiation structure 12 transmits the electromagnetic wave to the first feed line 112 and the second feed line 212 through the first opening 501 and the second opening 502 in the first reference electrode layer; the first feed line 112 transmits the electromagnetic wave to the first phase adjustment structure 11, the first phase adjustment structure 11 performs phase shift modulation on the electromagnetic wave and transmits the electromagnetic wave to the reflective layer, and the reflective layer reflects the electromagnetic wave to the first radiation structure 12; the second feed line 212 transmits the electromagnetic wave to the second phase adjustment structure 21, the second phase adjustment structure 21 performs phase shift modulation on the electromagnetic wave and transmits the electromagnetic wave to the reflective layer, and the reflective layer reflects the electromagnetic wave to the first radiation structure 12; and the two electromagnetic waves are combined, and radiated outside through the first radiation structure 12.

In addition, the reflective antenna may further includes a third dielectric substrate 30 and a fourth dielectric substrate 40, where the third dielectric substrate 30 is disposed on a side of the first reference electrode layer 50 distal to the second dielectric substrate 20, and the fourth dielectric substrate 40 is disposed on a side of the second reference electrode layer 60 distal to the first dielectric substrate 10. In this case, the first radiation structure 12 may be arranged on the third dielectric substrate 30, and for example, on a side of the third dielectric substrate 30 distal to the second dielectric substrate 20. The second reference electrode layer 60 may be formed on the fourth dielectric substrate 40 and then attached to the first dielectric substrate 10.

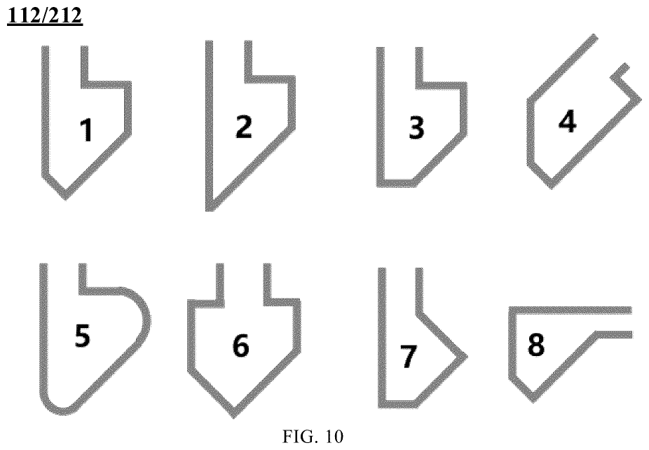

In some examples, FIG. 9 is a schematic diagram illustrating the first opening 501 and the second opening 502 according to an embodiment of the present disclosure. As shown in FIG. 9, a shape of each of the first opening 501 and the second opening 502 may be any shape such as a U-shape, a linear-segment shape, an H-shape, an open-ring shape (i.e., a ring shape with an opening), or the like. Further, in the case where each of the first opening 501 and the second opening 502 is an opening having the linear-segment shape, a width of a central region of the linear-segment shape is not greater than a width of each of the both ends of the linear-segment shape, and for example, each side of each of the first opening 501 and the second opening 502 along the respective extending direction of each of the first opening 501 and the second opening 502 may be an arc or a broken line. The present embodiment takes an example in which each of the first opening 501 and the second opening 502 is a U-shaped opening. In some examples, the first opening 501 and the second opening 502 in the first reference electrode layer 50 are arranged to be mirror-symmetrical to each other. At least a part of the structure of the first feed line 112 and the second feed line 212 is located between the regions defined by the first opening 501 and the second opening 502. For example, an orthogonal projection of the second sub-feed line 1122 of the first feed line 112 on the first dielectric substrate 10 and an orthogonal projection of the fourth sub-feed line 2122 of the second feed line 212 on the first dielectric substrate 10 are located in a region between an orthogonal projection of the first opening 501 on the first dielectric substrate 10 and an orthogonal projection of the second opening 502 on the first dielectric substrate 10.

With continuing reference to FIG. 8, the first feed line 112 and the second feed line 212 may be arranged to be mirror-symmetrical to each other, i.e., the wire winding of the first feed line 112 is identical to the wire winding of the second feed line 212. The relative positional relationship between the first feed line 112 and the first opening 501 is the same as the relative positional relationship between the second feed line 212 and the second opening 502, and the following description will be given by taking only the relative positional relationship between the first feed line 112 and the first opening 501 as an example. An intersection point of the orthogonal projection of the first feed line 112 on the first dielectric substrate 10 and the orthogonal projection of the first opening 501 on the first dielectric substrate 10 is an orthogonal projection of the first feed point E1 of the first feed line 112 on the first dielectric substrate 10. The first opening 501 includes a first sub-opening, and a second sub-opening and a third sub-opening which are connected to both ends of the first sub-opening, and the orthogonal projection of the first feed point El on the first dielectric substrate 10 coincides with a midpoint of an orthogonal projection of the first sub-opening on the first dielectric substrate 10. The second sub-opening and the third sub-opening are symmetrically arranged with respect to a straight line, which passes through the first feed point E1 and is perpendicular to the first sub-opening. The wire winding of the first feed line 112 should be spaced apart from any portion, other than the first feed point E1, of the first opening 501 to avoid signal coupling. As can be seen from FIG. 7, the points C and D on the first opening 501 are close (i.e., have a small distance) to the first feed line 112, and therefore, it is necessary to set the distance at these two positions reasonably. FIG. 10 is a schematic diagram illustrating the wire winding of each of the first feed line 112 and the second feed line 212 according to an embodiment of the present disclosure, and as shown in FIG. 10, the wire winding of each of the first feed line 112 and the second feed line 212 is not limited to the one shown in FIG. 7.

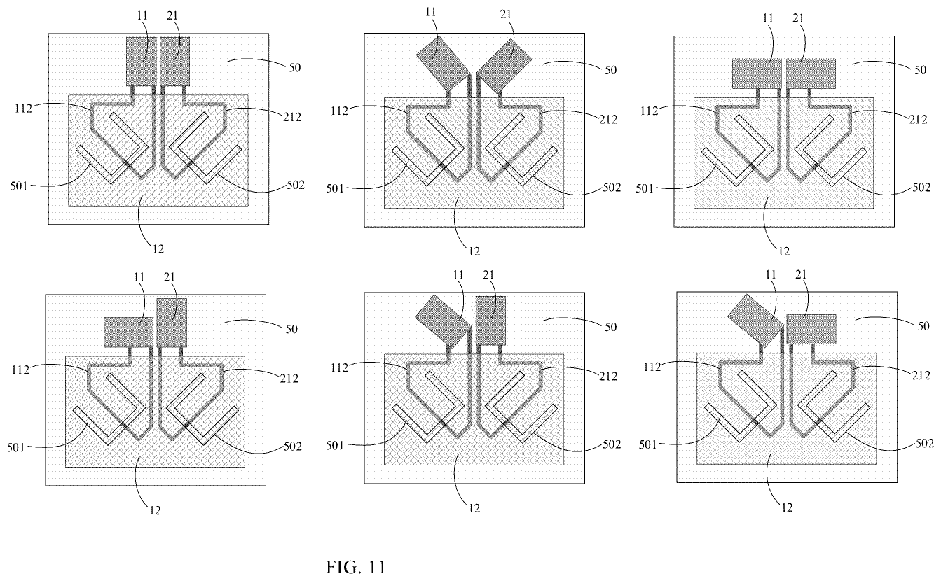

In some examples, FIG. 11 is a schematic diagram illustrating relative positions of the first phase adjustment structure 11 and the second phase adjustment structure 21 according to an embodiment of the present disclosure. As shown in FIG. 11, the first phase adjustment structure 11 and the second phase adjustment structure 21 may be arranged horizontally, vertically, inclined to each other, or the like. The first phase adjustment structure 11 and the second phase adjustment structure 21 are reasonably arranged to ensure that two phase adjustment structures can be set in one antenna, and meanwhile, to ensure clear interfaces, easy feeding, and the like.

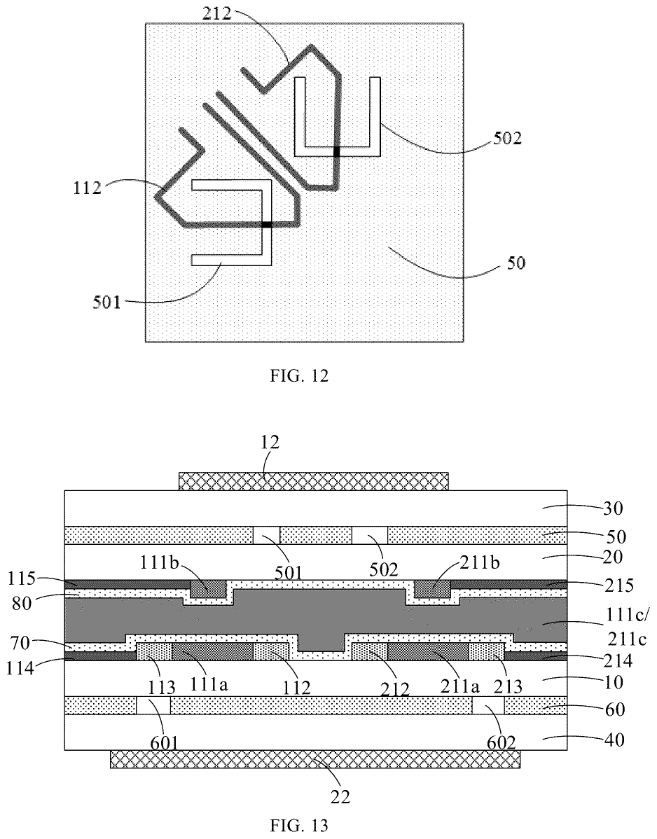

In some examples, FIG. 12 is a schematic diagram illustrating another relative positional relationship among the first opening 501, the second opening 502, the first feed line 112, and the second feed line 212 according to an embodiment of the present disclosure. As shown in FIG. 12, the antenna according to an embodiment of the present disclosure may have various polarization forms, which may be, but are not limited to, horizontal polarization, vertical polarization, various circular polarizations, etc., as long as the first feed line 112, the second feed line 212, and the first radiation structure 12 are correspondingly rotated and adjusted.

In some examples, as shown in FIG. 8, the first electrode layer 111a in the first phase adjustment structure 11 is supplied with a bias voltage by a first bias voltage line 114, and the second electrode layer 111b in the first phase adjustment structure 11 is supplied with a bias voltage by a second bias voltage line 115. The first bias voltage line 114 may be disposed on a side of the first electrode layer 111a proximal to the first dielectric substrate 10 and directly connected to the first electrode layer 111a, and the second bias voltage line 115 may be disposed on a side of the second electrode layer 111b proximal to the second dielectric substrate 20. Alternatively, a first insulating layer 70 is further disposed on a side, which is proximal to the liquid crystal layer, of a layer where the first electrode layer 111a and a third electrode layer 211a are located, and a second insulating layer 80 is further disposed on a side, which is proximal to the liquid crystal layer, of a layer where the second electrode layer 111b and the fourth electrode layer 211b are located.

For example, in the case where the first electrode layer 111a includes the first transmission line 1111 and the second electrode layer 111b includes the second transmission line 2111, the first transmission line 1111 is electrically connected to the first bias voltage line 114, and the second transmission line 2111 is electrically connected to the second bias voltage line 115. In the case where the first electrode layer 111a includes the first transmission line 1111 and the second transmission line 2111 and the second electrode layer 111b includes the plurality of first patch electrodes 2112, both the first transmission line 1111 and the second transmission line 2111 are electrically connected to the first bias voltage line 114, and the plurality of first patch electrodes 2112 are electrically connected to the second bias voltage line 115. In the case where the third electrode layer 211a includes the third transmission line and the fourth electrode layer 211b includes the fourth transmission line, the third transmission line is electrically connected to a third bias voltage line 214, and the fourth transmission line is electrically connected to a fourth bias voltage line 215. In the case where the third electrode layer 211a includes the third transmission line and the fourth transmission line, and the fourth electrode layer 211b includes a plurality of second patch electrodes 2112, both the third transmission line and the fourth transmission line are electrically connected to the third bias voltage line 214, and the plurality of second patch electrodes 2112 are electrically connected to the fourth bias voltage line 215.

In a second exemplary embodiment, FIG. 13 is a sectional view illustrating a second exemplary antenna according to an embodiment of the present disclosure. As shown in FIG. 13, the antenna is a transmissive antenna, and includes not only the first phase adjustment structure 11, the second phase adjustment structure 21, the first feed line 112, the second feed line 212, and the first radiation structure 12, but also the first dielectric substrate 10, the second dielectric substrate 20, the third dielectric substrate 30, the fourth dielectric substrate 40, a second radiation structure 22, the first reference electrode layer 50, and the second reference electrode layer 60. The first phase adjustment structure 11 and the second phase adjustment structure 21 are integrated between the first dielectric substrate 10 and the second dielectric substrate 20. The first reference electrode layer 50 is disposed on the side of the second dielectric substrate 20 distal to the first dielectric substrate 10, and the first reference electrode layer 50 has therein the first opening 501 and the second opening 502. The third dielectric substrate 30 is arranged on the side of the first reference electrode layer 50 distal to the second dielectric substrate 20, and the first radiation structure 12 is arranged on the side of the third dielectric substrate 30 distal to the first reference electrode layer 50. The second reference electrode layer 60 is arranged on the side of the first dielectric substrate 10 distal to the second dielectric substrate 20, and the second reference electrode layer 60 has therein a third opening 601 and a fourth opening 602. The fourth dielectric substrate 40 is arranged on the side of the second reference electrode layer 60 distal to the first dielectric substrate 10, and the second radiation structure 22 is arranged on a side of the fourth dielectric substrate 40 distal to the second reference electrode layer 60. The first feed line 112 is electrically connected to the first radiation structure 12 through the first opening 501, and the transmission assembly of the first phase adjustment structure 11 is electrically connected to the second radiation structure 22 through the third opening 601. The second feed line 212 is electrically connected to the first radiation structure 12 through the second opening 502, and the transmission assembly of the second phase adjustment structure 21 is electrically connected to the second radiation structure 22 through the fourth opening 602.

The first feed line 112, the second feed line 212, the first opening 501, and the second opening 502 may be designed in the same manner as that described in the first exemplary embodiment, and therefore, detailed description thereof is omitted here.

In some examples, each of the transmission assembly of the first phase adjustment structure 11 and the transmission assembly of the second phase adjustment structure 21 may be the balun assembly described above, and may also adopt a feeder structure. The present embodiment takes an example in which the transmission assembly of the first phase adjustment structure 11 is a third feed line, and the transmission assembly of the second phase adjustment structure 21 is a fourth feed line. Each of the third feed line and the fourth feed line may have a similar structure as that of each of the first feed line 112 and the second feed line 212, and similarly, each of the third opening 601 and the fourth opening 602 may have a similar structure as that of each of the first opening 501 and the second opening 502. The third feed line is coupled to the second radiation structure 22 through the third opening 601, similar to the manner in which the first feed line 112 is coupled to the first radiation structure 12 through the first opening 501. Similarly, the fourth feed line is coupled to the second radiation structure 22 through the fourth opening 602, similar to the manner in which the second feed line 212 is coupled to the first radiation structure 12 through the second opening 502.

Each of the third feed line and the fourth feed line has a first end and a second end. The first end of the third feed line is electrically connected to the first transmission line 1111, and the second end of the third feed line is electrically connected to the second transmission line 2111. The first end of the fourth feed line is electrically connected to the third transmission line, and the second end of the fourth feed line is electrically connected to the fourth transmission line.

Further, a feed point for the third feed line to feed a signal to the second radiation structure 22 is a third feed point, and a feed point for the fourth feed line to feed a signal to the second radiation structure 22 is a fourth feed point. The third feed point divides the third feed line into a fifth sub-feed line and a sixth sub-feed line, and the fourth feed point divides the fourth feed line into a seventh sub-feed line and an eighth sub-feed line. A length of the fifth sub-feed line and a length of the sixth sub-feed line are equal to each other, and a length of the seventh sub-feed line and a length of the eighth sub-feed line are equal to each other.

Further, at least one of the fifth sub-feed line and the sixth sub-feed line of the third feed line includes a serpentine line, and/or at least one of the seventh sub-feed line and the eighth sub-feed line of the fourth feed line includes a serpentine line.

In an embodiment of the present disclosure, the third feed line and the fourth feed line are arranged to be mirror-symmetrical to each other, and the third opening 601 and the fourth opening 602 may also be arranged to be mirror-symmetrical to each other. Such an arrangement is similar to that of the first feed line 112, the first opening 501, the second feed line 212, and the second opening 502, and therefore, the detailed description thereof is omitted here.

In a third exemplary embodiment, FIG. 14 is a sectional view illustrating a third exemplary antenna according to an embodiment of the present disclosure. As shown in FIG. 14, the antenna is a phased array antenna, and includes not only the first phase adjustment structure 11, the second phase adjustment structure 21, the first feed line 112, the second feed line 212, and the first radiation structure 12, but also the first dielectric substrate 10, the second dielectric substrate 20, the third dielectric substrate 30, the fourth dielectric substrate 40, the first reference electrode layer 50, the second reference electrode layer 60, a first feed source 13, and a second feed source 23. The first phase adjustment structure 11 and the second phase adjustment structure 21 are integrated between the first dielectric substrate 10 and the second dielectric substrate 20. The first reference electrode layer 50 is disposed on the side of the second dielectric substrate 20 distal to the first dielectric substrate 10, and the first reference electrode layer 50 has therein the first opening 501 and the second opening 502. The third dielectric substrate 30 is arranged on the side of the first reference electrode layer 50 distal to the second dielectric substrate 20, and the first radiation structure 12 is arranged on the side of the third dielectric substrate 30 distal to the first reference electrode layer 50. The second reference electrode layer 60 is arranged on the side of the first dielectric substrate 10 distal to the second dielectric substrate 20, and the second reference electrode layer 60 has therein the third opening 601 and the fourth opening 602. The fourth dielectric substrate 40 is arranged on the side of the second reference electrode layer 60 distal to the first dielectric substrate 10, and the first feed source 13 and the second feed source 23 are arranged on the side of the fourth dielectric substrate 40 distal to the second reference electrode layer 60. The first feed line 112 is electrically connected to the first radiation structure 12 through the first opening 501, and the transmission assembly of the first phase adjustment structure 11 is electrically connected to the first feed source through the third opening 601. The second feed line 212 is electrically connected to the first radiation structure 12 through the second opening 502, and the transmission assembly of the second phase adjustment structure 21 is electrically connected to the second feed source through the fourth opening 602.

The first feed line 112, the second feed line 212, the first opening 501, and the second opening 502 may be arranged in the manner as that described in the first exemplary embodiment, and therefore, the detailed description thereof is omitted here.

In some examples, each of the transmission assembly of the first phase adjustment structure 11 and the transmission assembly of the second phase adjustment structure 21 may be the balun assembly described above, or may be a feeder structure. The present embodiment takes an example in which the transmission assembly of the first phase adjustment structure 11 is a third feed line, and the transmission assembly of the second phase adjustment structure 21 is a fourth feed line. Each of the third feed line and the fourth feed line may have a similar structure as that of each of the first feed line 112 and the second feed line 212, and similarly, each of the third opening 601 and the fourth opening 602 may have a similar structure as that of each of the first opening 501 and the second opening 502. The third feed line is coupled to the first feed source 13 through the third opening 601, similar to the manner in which the first feed line 112 is coupled to the first radiation structure 12 through the first opening 501. Similarly, the fourth feed line is coupled to the second feed source 23 through the fourth opening 602, similar to the manner in which the second feed line 212 is coupled to the first radiation structure 12 through the second opening 502.

Each of the third feed line and the fourth feed line has a first end and a second end. The first end of the third feed line is electrically connected to the first transmission line 1111, and the second end of the third feed line is electrically connected to the second transmission line 2111. The first end of the fourth feed line is electrically connected to the third transmission line, and the second end of the fourth feed line is electrically connected to the fourth transmission line.

Further, a feed point for the third feed line to feed a signal to the first feed source 13 is a third feed point, and a feed point for the fourth feed line to feed a signal to the second feed source 23 is a fourth feed point. The third feed point divides the third feed line into a fifth sub-feed line and a sixth sub-feed line, and the fourth feed point divides the fourth feed line into a seventh sub-feed line and an eighth sub-feed line. A length of the fifth sub-feed line and a length of the sixth sub-feed line are equal to each other, and a length of the seventh sub-feed line and a length of the eighth sub-feed line are equal to each other.

Further, at least one of the fifth sub-feed line and the sixth sub-feed line of the third feed line includes a serpentine line, and/or at least one of the seventh sub-feed line and the eighth sub-feed line of the fourth feed line includes a serpentine line.

In an embodiment of the present disclosure, the third feed line and the fourth feed line are arranged to be mirror-symmetrical to each other, and the third opening 601 and the fourth opening 602 may also be arranged to be mirror-symmetrical to each other. Such an arrangement is similar to that of the first feed line 112, the first opening 501, the second feed line 212, and the second opening 502, and therefore, the detailed description thereof is omitted here.

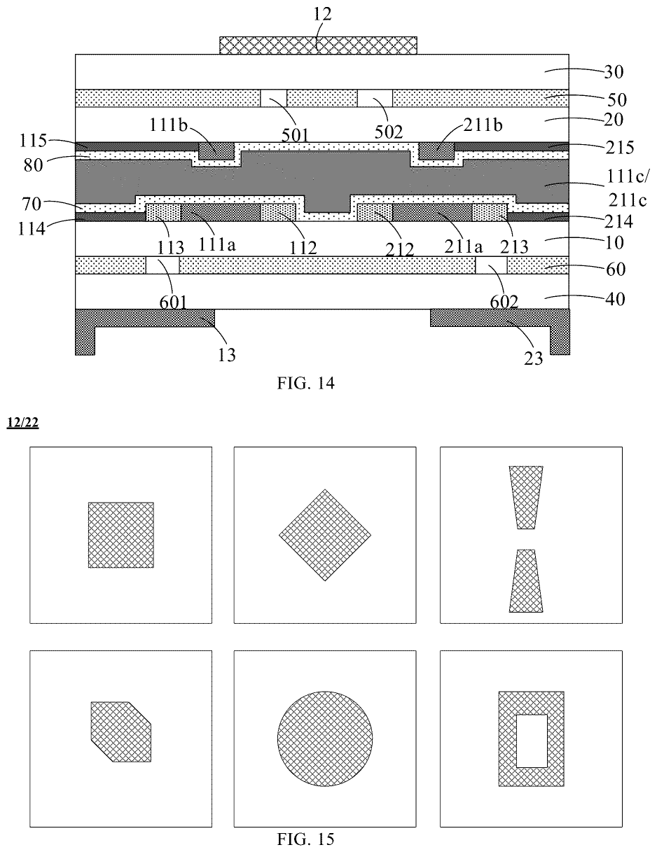

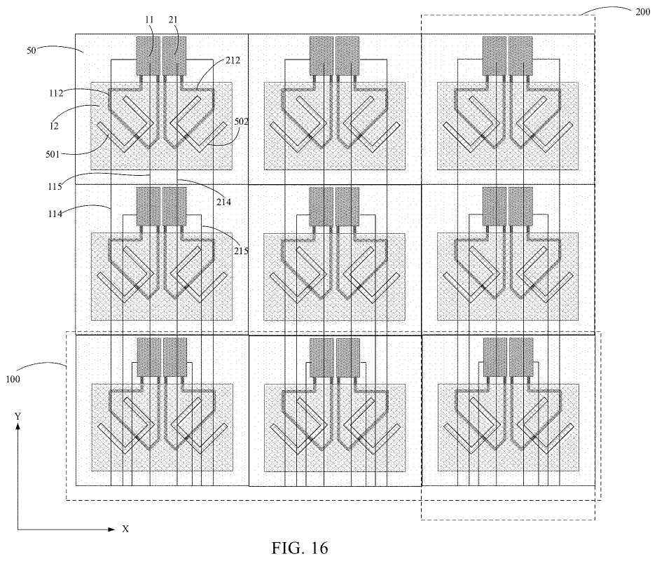

Regardless of that the antenna according to an embodiment of the present disclosure adopts any one of the above-described structures, in some examples, FIG. 15 is a schematic diagram illustrating the first/second radiation structure 12/22 according to an embodiment of the present disclosure. As shown in FIG. 15, each of the first radiation structure 12 and the second radiation structure 22 according to an embodiment of the present disclosure may be a radiation patch, a monopole antenna, or the like. In the present embodiment, the first radiation structure 12 is exemplified by a radiation patch, which may be in various shapes such as a square, a diamond, a butterfly shape, a hexagon, a circle, a ring, or the like, and is configured to provide polarities having different properties and different performances. In the present embodiment, the shape of the first radiation structure 12 is exemplified by a square only.

Further, each of a length and a width of the first radiation structure 12 ranges from 0.1 λ to 1 λ, where λ is an operating wavelength of the first radiation structure 12. The first radiation structure 12 may be a single-layer electrically conductive structure, or may be a composite-layer structure, for example, the first radiation structure 12 is formed by stacking a base material and a conductive layer together.

It should be noted that in the case where the antenna is a transmissive antenna, the second radiation structure 22 may have the same structure as that of the first radiation structure 12, and therefore, detailed description thereof is omitted here.

Regardless of that the antenna according to an embodiment of the present disclosure adopts any one of the above-described structures, in some examples, a material of each of the first electrode layer 111a, the second electrode layer 111b, the third electrode layer 211a, the fourth electrode layer 211b, the first reference electrode layer 50, the second reference electrode layer 60, the first radiation structure 12, the second radiation structure 22, the first feed line 112, the second feed line 212, the third feed line, and the fourth feed line includes, but is not limited to, a metal material such as copper, silver, aluminum, or the like. A material of each of the first bias voltage line 114, the second bias voltage line 115, the third bias voltage line 214, and the fourth bias voltage line 215 includes, but is not limited to indium tin oxide (ITO). Each of the first dielectric substrate 10, the second dielectric substrate 20, the third dielectric substrate 30, and the fourth dielectric substrate 40 includes, but is not limited to, various dielectric materials such as glass, PCB board, and/or ceramic.

An embodiment of the present disclosure provides an antenna array including a plurality of antennas, each of which is the antenna according to any one of the foregoing embodiments. The plurality of antennas includes a plurality of first antenna groups 100 arranged side by side along a second direction Y and a plurality of second antenna groups 200 arranged side by side along a first direction X. The antennas in each first antenna group 100 are arranged side by side in the first direction, and the antennas in each second antenna group 200 are arranged side by side in the second direction.

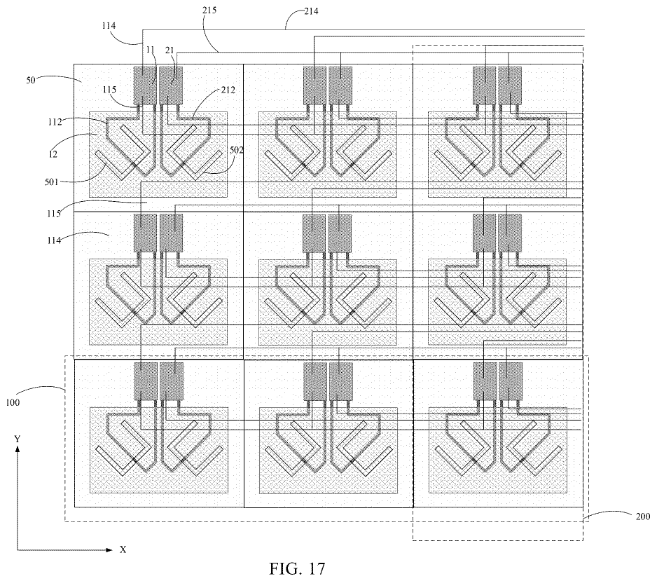

In some examples, FIG. 16 is a schematic diagram illustrating a layout of an antenna array according to an embodiment of the present disclosure. As shown in FIG. 16, in each second antenna group 200, the first electrode layers 111a are connected to separate first bias voltage lines 114, respectively, the third electrode layers 211a are connected to a same third bias voltage line 214, the second electrode layers 111b are connected to a same second bias voltage line 115, and the fourth electrode layers 211b are connected to separate fourth bias voltage lines 215, respectively. Such an arrangement can reduce the wiring of the antenna array and is convenient for realizing the miniaturization of the antenna array. Alternatively, in each second antenna group 200, the first electrode layers 111a are connected to a same first bias voltage line 114, the third electrode layers 211a are connected to separate third bias voltage lines 214, respectively, the second electrode layers 111b are connected to separate second bias voltage lines 115, respectively, and the fourth electrode layers 211b are connected to a same fourth bias voltage line 215.

In some examples, FIG. 17 is a schematic diagram illustrating another layout of an antenna array according to an embodiment of the present disclosure. As shown in FIG. 17, in each first antenna group 100, the first electrode layers 111a are connected to separate first bias voltage lines 114, respectively, the third electrode layers 211a are connected to a same third bias voltage line 214, the second electrode layers 111b are connected to a same second bias voltage line 115, and the fourth electrode layers 211b are connected to separate fourth bias voltage lines 215, respectively. Such an arrangement can reduce the wiring of the antenna array and is convenient for realizing the miniaturization of the antenna array. Alternatively, in each first antenna group 100, the first electrode layers 111a are connected to a same first bias voltage line 114, the third electrode layers 211a are connected to separate third bias voltage lines 214, respectively, the second electrode layers 111b are connected to separate second bias voltage lines 115, respectively, and the fourth electrode layers 211b are connected to a same fourth bias voltage line 215.

An embodiment of the present disclosure provides an electronic device, which includes the antenna array according to any one of the foregoing embodiments.

The antenna array according to an embodiment of the present disclosure further includes a transceiver unit, a radio frequency transceiver, a signal amplifier, a power amplifier, and/or a filter unit. An antenna of the antenna array may serve as a transmitting antenna or a receiving antenna. The transceiver unit may include a baseband and a receiving terminal, where the baseband provides signals of at least one frequency band, for example, provides 2G signals, 3G signals, 4G signals, 5G signals, etc., and sends the signals of at least one frequency band to the radio frequency transceiver. After receiving the signals, an antenna of a communication system may transmit the signals to the receiving terminal of the transceiver unit after the signals being processed by the filter unit, the power amplifier, the signal amplifier, and the radio frequency transceiver, where the receiving terminal may be, for example, an intelligent gateway.

Further, the radio frequency transceiver is connected to the transceiver unit, and is configured to modulate a signal sent by the transceiver unit, or demodulate a signal received by the antenna and transmit the modulated signal to the transceiver unit. Specifically, the radio frequency transceiver may include a transmitting circuit, a receiving circuit, a modulating circuit, and a demodulating circuit, where after the transmitting circuit receives signals of various types provided by the baseband, the modulating circuit may modulate the signals of various types provided by the baseband and then send the modulated signals to the antenna. The antenna receives the signals and transmits the signals to the receiving circuit of the radio frequency transceiver, the receiving circuit transmits the signals to the demodulating circuit, and the demodulating circuit demodulates the signals and transmits the demodulated signals to the receiving terminal.

Further, the radio frequency transceiver is connected to the signal amplifier and the power amplifier which are further connected to the filter unit, and the filter unit is connected to at least one antenna. During the process of sending signals by the communication system, the signal amplifier improves a signal-to-noise ratio of a signal output by the radio frequency transceiver and then transmits the signal to the filter unit; the power amplifier amplifies a power of the signal output by the radio frequency transceiver and then transmits the signal to the filter unit; the filter unit may specifically include a duplexer and a filtering circuit, the filter unit combines the signals output by the signal amplifier and the power amplifier, filters out noise waves, and then transmits the combined signal to the antenna, and the antenna radiates the signal outside. During the process of receiving a signal by the communication system, the signal received by the antenna is transmitted to the filter unit, the filter unit filters the signal received by the antenna to remove noise waves and then transmits the signal to the signal amplifier and the power amplifier, the signal received by the antenna is gained by the signal amplifier to increase the signal-to-noise ratio of the signal; and the power amplifier amplifies the power of the signal received by the antenna. The signal received by the antenna is processed by the power amplifier and the signal amplifier and then transmitted to the radio frequency transceiver, and the radio frequency transceiver transmits the signal to the transceiver unit.

In some examples, the signal amplifier may include any one of signal amplifiers of various types, such as a low noise amplifier, which is not limited herein.

In some examples, the antenna array according to an embodiment of the present disclosure further includes a power management unit, where the power management unit is connected to the power amplifier and provides the power amplifier with a voltage for amplifying a signal.

It should be understood that the foregoing embodiments are merely exemplary embodiments adopted to illustrate the principles of the present disclosure, and the present disclosure is not limited thereto. It will be apparent to one of ordinary skill in the art that various modifications and improvements may be made therein without departing from the spirit and scope of the present disclosure, and such modifications and improvements are also considered to be within the scope of the present disclosure.

1. A dimming device, comprising a first substrate, a second substrate, a first adhesive layer, a second adhesive layer, and a dimming assembly; wherein
the first substrate, the first adhesive layer, the dimming assembly, the second adhesive layer and the second substrate are sequentially stacked together;
the dimming assembly comprises a third substrate, a first sealant, a plurality of spacers, and a fourth substrate, the third substrate and the fourth substrate are aligned and assembled to form an alignment gap therebetween, and liquid crystal is filled in the alignment gap;
the plurality of spacers are positioned between the third substrate and the fourth substrate, and positioned in a region surrounded by the first sealant;
the first sealant is positioned between the third substrate and the fourth substrate, and surrounds peripheral regions of the third substrate and the fourth substrate, so as to bond and encapsulate the peripheral regions of the third substrate and the fourth substrate;
the first adhesive layer and the second adhesive layer at least cover an effective dimming region of the dimming assembly;
the effective dimming region is a region surrounded by the first sealant; and
each of the first adhesive layer and the second adhesive layer is a solid adhesive; or, at least one of the first adhesive layer and the second adhesive layer is made of a liquid adhesive.

2. The dimming device according to claim 1, wherein orthogonal projections of a first side of the dimming assembly, the first adhesive layer, and the second adhesive layer on a plane where the first substrate is located do not overlap with each other; and
the first sealant extends at the first side to form at least one opening, an end of each opening is flush with first sides of the third substrate and the fourth substrate, and is sealed by an opening-sealing adhesive, and the at least one opening is configured to fill the liquid crystal into the alignment gap.

3. The dimming device according to claim 2, wherein the first adhesive layer and the second adhesive layer extend to and encapsulate end faces of other sides of the dimming assembly except the first side; and
wherein orthogonal projections of the first substrate, the second substrate, the first adhesive layer and the second adhesive layer on the plane where the first substrate is located coincide with each other.

4. (canceled)

5. The dimming device according to claim 1, wherein the first sealant surrounds to form a closed ring shape;
the first adhesive layer and the second adhesive layer extend to and encapsulate an end face of a periphery of the dimming assembly; and
a periphery of an orthogonal projection of each of the first adhesive layer and the second adhesive layer on the first substrate surrounds outside a periphery of an orthogonal projection of the first sealant on the first substrate.

6. The dimming device according to claim 3, wherein orthogonal projections of the first substrate and the second substrate on a plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on a plane where the first substrate is located surrounds outside a periphery of each of the orthogonal projections of the first adhesive layer and the second adhesive layer on the plane where the first substrate is located.

7. The dimming device according to claim 6, further comprising a second sealant, which is disposed between the first substrate and the second substrate, surrounds the peripheral regions of the first substrate and the second substrate, and is in contact with and connected to the first substrate and the second substrate; and
an orthogonal projection of the second sealant on the first substrate is positioned outside the orthogonal projections of the first adhesive layer and the second adhesive layer on the first substrate.

8. The dimming device according to claim 2, wherein orthogonal projections of other sides of the first substrate, the dimming assembly, and the second substrate except the first side on the plane where the first substrate is located overlap with each other;
orthogonal projections of the other sides of the dimming assembly except the first side, the first adhesive layer, and the second adhesive layer on the plane where the first substrate is located do not overlap with each other;
orthogonal projections of the first substrate and the second substrate on the plane where the first substrate is located coincide with each other;
the orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

9. The dimming device according to claim 1, wherein the first sealant surrounds to form a closed ring shape;
orthogonal projections of peripheries of the first substrate, the dimming assembly, and the second substrate on a plane where the first substrate is located overlap with each other;
orthogonal projections of a periphery of the dimming assembly, the first adhesive layer, and the second adhesive layer on the plane where the first substrate is located do not overlap with each other;
orthogonal projections of the first substrate and the second substrate on the plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

10. The dimming device according to claim 8, further comprising a second sealant, which is disposed between the first substrate and the dimming assembly, surrounds peripheral regions of the first substrate and the dimming assembly, and is in contact with and connected to the first substrate and the dimming assembly;
the second sealant is further positioned between the second substrate and the dimming assembly, surrounds the peripheral regions of the second substrate and the dimming assembly, and is in contact with and connected to the second substrate and the dimming assembly; and
an orthogonal projection of the second sealant on the first substrate is positioned outside each of orthogonal projections of the first adhesive layer and the second adhesive layer on the first substrate.

11. The dimming device according to claim 3, wherein the first adhesive layer and the second adhesive layer are both the solid adhesives;
or, one of the first adhesive layer and the second adhesive layer is made of the liquid adhesive; and
each solid adhesive comprises polyvinyl butyral or ethylene-vinyl acetate copolymer.

12. The dimming device according to claim 8, wherein each of the first adhesive layer and the second adhesive layer is made of the liquid adhesive which achieves adhesion after being cured; and
the liquid adhesive comprises an acrylic resin optical adhesive or an organic silicon optical adhesive.

13. The dimming device according to claim 10, wherein the second sealant has a width in a range of 2 mm to 6 mm.

14. The dimming device according to claim 2, further comprising an edge-sealing adhesive, which is located on the first side of the dimming assembly, and on a side of the opening-sealing adhesive distal to the at least one opening; and
the edge-sealing adhesive extends to cover the first side.

15. The dimming device according to claim 14, wherein the edge-sealing adhesive has a width in a range of 1 cm to 2 cm.

16. The dimming device according to claim 1, wherein the third substrate comprises a first flexible substrate, a first electrode layer, and a first alignment film;
the first electrode layer and the first alignment film are sequentially stacked on the first flexible substrate;
the fourth substrate comprises a second flexible substrate, a second electrode layer, and a second alignment film;
the second electrode layer and the second alignment film are sequentially stacked on the second flexible substrate;
the plurality of spacers are uniformly distributed on the first electrode layer; and
a top end of at least a part of the spacers is in contact with the second alignment film.

17. The dimming device according to claim 16, wherein the first electrode layer further extends beyond the first sealant and forms a first binding electrode;
the second electrode layer further extends beyond the first sealant and forms a second binding electrode;
the first binding electrode and the second binding electrode are positioned on a same side of the dimming assembly, and orthogonal projections of the first binding electrode and the second binding electrode on the first flexible substrate do not overlap with each other;
the dimming device further comprises a first flexible circuit board and a second flexible circuit board;
the first binding electrode is bound and connected to the first flexible circuit board; and
the second binding electrode is bound and connected to the second flexible circuit board.

18. The dimming device according to claim 16, wherein a shape of each of the spacers comprises any one of a cylinder, a frustum of a cone, or a frustum of a pyramid.

19. The dimming device according to claim 18, wherein each spacer having the shape of a frustum of a cone has a bottom surface of which a diameter is in a range of 25 μm to 30 μm, a top surface of which a diameter is in a range of 15 μm to 20 μm, and a height in a range of 8 μm to 12 μm.

20. The dimming device according to claim 16, wherein a distance between any adjacent two of the spacers is in a range of 70 μm to 170 μm; and
a distance between the spacer closest to the first sealant and the first sealant is in a range of 100 μm to 1,000 μm.

21. A vehicle, comprising the dimming device according to claim 1, wherein the dimming device serves as a window of the vehicle.

22-24. (canceled)
